(19) United States
(12) Patent Application Publication
(10) Pub. No.: US 2020/0005561 A1
(43) Pub. Date: Jan. 2, 2020

(54) METHOD FOR SETTING AN IUMPR OF A VEHICLE, COMPUTER PROGRAM, MEMORY MEANS, CONTROL UNIT AND VEHICLE

(71) Applicant: VOLKSWAGEN AKTIENGESELLSCHAFT, Wolfsburg (DE)

(72) Inventors: Ulrich SCHRÖDER, Braunschweig (DE); Michael TOMFORDE, Gifhorn (DE); Christian DIERSCHKE, Goslar (DE); Daniel LEINEWEBER, Braunschweig (DE); Johannes FORST, Hannover (DE)

(73) Assignee: VOLKSWAGEN AKTIENGESELLSCHAFT, Wolfsburg (DE)

(21) Appl. No.: 16/451,275

(22) Filed: Jun. 25, 2019

(30) Foreign Application Priority Data
Jul. 2, 2018 (DE) 10 2018 210 857.9

(51) Int. Cl. G07C 5/08; B60W 50/00

(52) U.S. Cl. CPC G07C 5/0808; B60W 2050/0083; B60W 50/00

(57) ABSTRACT

The present invention relates to a method for setting an IUMPR of a vehicle, wherein the IUMPR comprises a numerator for indicating a number of possible sequences of diagnostic functions and a denominator for indicating a number of predefined operating states that have prevailed in the vehicle, wherein it is ascertained, on the basis of physical operating parameters of the vehicle, whether at least one diagnostic function can be carried out for ascertaining the functional capability of at least one function component of the vehicle, and then it is ascertained, depending on prevailing operating sequences in the vehicle and/or operating sequences yet to be carried out, whether a diagnostic mode of at least one function component for carrying out the at least one diagnostic function is available or can be set, such that the numerator of the IUMPR is incremented when it is detected that the diagnostic mode is available or can be set. The invention also relates to a computer program, a memory means, a control unit and a motor vehicle.

### FIELD OF THE INVENTION

The present invention relates to a method, a computer program, a memory means, a control unit and a vehicle, with which statutory provisions with regard to the necessary diagnostic functions for setting IUMPRs (in use motion performance ratios) of a vehicle can be taken into account.

### BACKGROUND OF THE INVENTION

Control units used with today's internal combustion engines implement a coordination of competing diagnostic functions and/or adaptations. Competing diagnostic functions are understood to be functions, which are mutually exclusive and/or influential, based on their system interventions, i.e., they are competitive. With the help of control units and/or suitably configured computer programs, the diagnostic functions required by lawmakers are coordinated centrally with regard to their feasibility at the present time.

In addition to carrying out diagnostic functions, the frequency, cycle and successful implementation of diagnostic functions must also be documented. This is achieved by using so-called ratios and/or the IUMPRs mentioned above. An IUMPR has a numerator and a denominator. The denominator stands for the number of defined driving cycles and is always incremented equally for all diagnostic functions when a driving cycle is detected. The numerator is based on a number of possible sequences of a diagnostic function during operation of the vehicle and is incremented when a diagnostic function with a result has been or could have been carried out and/or a result could have been obtained by means of the diagnostic function.

There are symmetrical ratios and asymmetrical ratios. It is possible to document whether a diagnosis or a diagnostic function has been carried out successfully by means of symmetrical ratios. Diagnostic functions with asymmetrical ratios and/or a corresponding calculation of the ratio require a longer execution time in the event of an error or a fault than would be necessary for quality control. Since the ratio could be increased only if an error/fault were found, it is necessary after the quality control, i.e., in a successful run, to check on whether an error could have been found for the time difference. In other words, information is needed about the possibility of the operability or feasibility of a diagnostic function.

In addition to the physical readiness of a diagnostic function, the only thing usually tested in current systems is whether the diagnostic function is blocked due to errors. For example, German Patent Application DE 103 02 054 A1 discloses a method for operating an internal combustion engine, in which there is a test of whether predefined requirements for carrying out a diagnostic function are met. According to DE 103 02 054 A1, a method is proposed for operating an internal combustion engine in a motor vehicle, in which the functional capability of at least one function component of the vehicle is tested by a diagnostic function, such that the diagnostic function transmits to a central function the information that it might have found an error/a fault, the transmission being in a format that is uniform for all diagnostic functions, and the central function processes this information.

However, systems according to DE 103 02 054 A1 only evaluate the conditions currently prevailing in the vehicle and/or in the internal combustion engine. Additional influences that might be added due to coordination of new central modes of operation are not taken into account. However, these can have an influence on the ratios and result in misinterpretations or inaccurate interpretations. Consequently, ratios may be increased falsely or incorrectly.

### SUMMARY OF THE INVENTION

The object of the present invention is to take into account, at least partially, the problems described above. In particular, the object of the present invention is to make available a method, a computer program, a memory means, a control unit and a vehicle, by means of which it is possible to achieve improved setting of one or more IUMPRs.

The object defined above is achieved by the patent claims. In particular the object is achieved by the method according to claim 1, the computer program according to claim 7, the memory means according to claim 8, the control unit according to claim 9 and the vehicle according to claim 10. Additional advantages of the invention are derived from the dependent claims, the description and the figures. Features described in conjunction with the method are of course also applicable in conjunction with the computer program, the memory means, the control unit and the vehicle according to the invention and also conversely, so that reference is or can always be made mutually with respect to the disclosure of the individual aspects of the invention.

According to a first aspect of the present invention, a method for setting an IUMPR of a vehicle is made available, wherein the IUMPR comprises a numerator for display of a number of possible sequences of diagnostic functions and a denominator for display of a number of predefined operating states that have prevailed in the vehicle. Within the scope of this method, there is a determination on the basis of physical operating parameters of the vehicle as to whether at least one diagnostic function can be carried out to ascertain the functional capability of at least one function component of the vehicle. Next, depending on current operating sequences in the vehicle or those yet to be carried out, there is a determination of whether a diagnostic mode of the at least one function component is available or can be set for carrying out the at least one diagnostic function, wherein the numerator of the IUMPR is incremented only on detection of the fact that the diagnostic mode is available or can be set.

It is proposed for the first time in the present case that information about diagnostic modes of the vehicle that can be set should be taken into account, for example, included in the calculations, to thereby be able to ensure that the at least one diagnostic function will be carried out successfully and/or be able to ensure that the at least one diagnostic function could have in fact been carried out or would have at least been advisable in reference to credible results.

With traditional methods and systems, it has been customary in the past to test only whether certain requirements, for example, predetermined operating states, prevail in the vehicle, such that a diagnostic function as such could theoretically have been carried out. It has not so far been customary to take into account the fact that, in certain operating states, it would be impossible or at least not advisable to actually carry out a diagnostic function because physical interactions in the vehicle, which could influence the measurement results in such a way as to render the result useless, might occur subsequently while the diagnostic function is being carried out. It is thus ensured that, according to the invention, current operating sequences and/or operating states and/or those yet to be performed or yet to occur in the vehicle would not result in competing diagnostic functions, i.e., diagnostic functions that would be mutually exclusive or at least would cause mutual interference due to their system intervention.

For example, if it is ascertained that the vehicle is driving steadily at a predefined operating point and the internal combustion engine of the vehicle is at a predefined temperature, then, theoretically, at least one diagnostic function might be implementable. However, if it is then ascertained in the next step that a predefined rotational speed of the internal combustion engine is necessary for successful implementation of the at least one diagnostic function, but this engine rotational speed cannot be set because the vehicle's particle filter is currently being burned off at a different rotational speed while carrying out the diagnostic function or must be regenerated, it is then ascertained or stipulated that the required diagnostic operating mode is not available or cannot be set. In this case, the numerator of the IUMPR is not incremented accordingly.

It may be advantageous if competing functions are linked to a diagnostic coordinator for coordinating various diagnostic functions. The signal link between the diagnostic coordinator and diagnostic functions preferably exists in both directions, so that the diagnostic functions can report to the diagnostic coordinator that there is a need for these diagnostic functions to be carried out, and the diagnostic coordinator may optionally send a release back to the respective diagnostic function, in particular after suitable coordination and prioritization, if any.

A distinction can be made in diagnostic functions between active and passive diagnostic functions. With active diagnostic functions, defined operating states, for example, a predefined engine condition of the internal combustion engine of the vehicle, such as certain camshaft target positions or types of injection must be set actively to be able to function correctly or to be able to arrive at the desired results. Active diagnostic functions include, for example, a parallelized catalyst diagnosis or a quantitative equivalency. A parallelized catalyst diagnosis is to be understood to refer to an active diagnosis of an internal combustion engine, in which engine parameters are set to achieve a targeted deviation from a normal condition, and in which two systems are diagnosed in parallel and/or simultaneously, for example, a catalyst and lambda probes of the vehicle. The quantitative equivalency may be understood to refer to a detection of component deviations in particular over the lifetime of the vehicle. The injectors of an internal combustion engine do not perform equally due to manufacturing tolerances and wear. In other words, at a predefined energization time different quantities of fuel are delivered by different injectors. Since the quantity of fuel should be identical for each cylinder and thus for each injector, the component deviations are determined. The deviations can be compensated accordingly based on this detection. Passive diagnostic functions cannot actively influence the condition of the engine; for example, they cannot trigger an adjustment of camshaft functions. However, passive diagnostic function may be capable of running only in certain engine conditions.

The physical operating parameters may be understood to include the rotational speed of the engine, the engine torque, engine temperature, exhaust temperature, speed of the vehicle, etc. Basically it should be possible to ascertain on the basis of the physical operating parameters of the vehicle whether that vehicle is in operation at all, for example, whether it is being driven and whether the at least one diagnostic function could be carried out at all at least theoretically with prospects of obtaining a designed diagnostic result.

The diagnostic mode may comprise one or more different operating states. A predefined operating state of the vehicle is understood to be an operating state in which the vehicle is operated at a predefined speed, for example, a predefined engine temperature and a corresponding exhaust temperature, and certain vehicle components are active or not. Within the scope of the present invention, it is ascertained whether a diagnostic mode of the at least one function components is or would be available or could be set for carrying out the at least one diagnostic function. In order for the diagnostic mode to be available or be set, the diagnostic mode must be available or settable with prospects of obtaining the desired or a suitably predefined diagnostic result, as explained above. The feasibility of the at least one diagnostic function may be understood to be the operability of the at least one diagnostic function.

The evaluation of the ratios is preferably carried out centrally by the engine control and/or a corresponding control unit of the vehicle based on coordination of operating mode and diagnosis. Setting the IUMPR, i.e., the ratio, can be understood to refer to calculation of at least one ratio or a plurality of ratios. The at least one function component may be understood to refer to vehicle components such as sensors, filters or catalysts, whose function must be verified in each case.

In addition or as an alternative to ascertaining which diagnostic function is to be carried out and/or whether the at least one diagnostic function is to be carried out, it is possible to ascertain which adaptations or other functions can be carried out. In other words, the at least one diagnostic function may be understood to refer to functions such as diagnoses, adaptations and the like.

According to another specific embodiment of the present invention, it is possible for a plurality of diagnostic functions to be prioritized relative to one another in one method and then to ascertain, as a function of the prioritized diagnostic functions, whether a diagnostic mode of the at least one function component is available or can be set for carrying out at least one diagnostic function. By prioritizing, it is possible to ensure that diagnostic functions that could mutually influence one another, whether through falsification of measured values or because both of the diagnostic functions would have to access the same actuator, cannot be carried out in parallel. For example, if two diagnostic functions that are incompatible with one another are to be requested or carried out, the diagnostic function having the higher priority is always enabled. This can be carried out automatically by a suitably configured control unit in the vehicle and/or a computer program installed in the vehicle.

In a method according to the invention, it may be advantageous if information about possibly carrying out the at least one diagnostic function and/or about the availability and/or settability of the diagnostic mode from a control unit in the motor vehicle is read out. In this way, all the information required for lawmakers can be made available in a clear and concise form at a central location and can be picked up easily accordingly.

Furthermore, it is possible to create an exclusion matrix in a method according to the present invention for specifying whether or not a plurality of diagnostic functions may take place at the same time, at least in part, such that a determination is made on the basis of the exclusion matrix to ascertain whether a diagnostic mode of the at least one function component is available or can be set for carrying out the diagnostic function. The exclusion matrix, preferably also like the prioritization described above, is stored, i.e., filed in a diagnostic coordinator. Together with the prioritization, the method for priority-based coordination is configured by competing functions and/or diagnostic functions. The coordination and/or a corresponding diagnostic coordinator decides which of the competing diagnostic functions and/or adaptations may run, i.e., be carried out. If release conditions have been met for the at least one diagnostic function, then the at least one diagnostic function will coordinate its request for a run with the diagnostic coordinator. The latter is preferably connected to a central engine coordination, from which it receives, for example, the information about which physical operating parameters are currently active, for example, in the form of an engine status, and which diagnostic modes can be set, for example, in the form of engine conditions.

For each diagnostic function, the diagnostic coordinator contains information about which diagnostic modes and/or with which operating parameters it is capable of running. When a passive diagnostic function is requested, first, a check is performed to ascertain whether or not this is capable of running with the current operating parameters and/or with the current mode. For active diagnostic functions, it is possible to check on whether the desired diagnostic mode can be set, for example, in the form of a desired and/or compatible engine condition. It is now possible that at least one diagnostic function may participate in prioritization only when such a setting is allowed.

Furthermore, in another embodiment variant of the present invention, it is possible that on the basis of the prioritized diagnostic functions as well as the exclusion matrix a test is carried out in the order of decreasing priority, to ascertain which diagnostic function can be carried out simultaneously, at least in part, with the highest priority diagnostic function. In other words, it is possible to ascertain which requesting diagnostic functions can be enabled in parallel with the highest priority diagnostic function. To do so, it is possible to store, in the diagnostic coordinator, which diagnostic functions are allowed to run together and which are not. This test is carried out in the order of decreasing priority. It is thus possible to check first on whether the diagnostic function of the second highest priority may be carried out together with the diagnostic function of the highest priority. If this is the case, then these diagnostic functions receive a corresponding release. Next, the diagnostic function with the third-highest priority can be tested for whether it is compatible with the two diagnostic functions released previously, etc. Each diagnostic function must be compatible with all of the more highly prioritized diagnostic functions for the releases.

In addition, with a specific embodiment of the invention, it is possible that a virtual request to run at least one diagnostic function is generated in a method, and then, on this basis, it is ascertained whether a diagnostic mode of the at least one function component is available or can be set for carrying out the at least one diagnostic function. To determine the possible operability in the case of a request for the at least one diagnostic function, there is preferably another evaluation in addition to the evaluation of the diagnostic functions currently being requested actively, and this additional evaluation preferably involves performing an evaluation of the requested diagnostic functions separately for each linked asymmetrical diagnostic function. In doing so, it is possible to evaluate for each diagnostic function whether the respective diagnostic function could be carried out at this point in time, if requested. For each diagnostic function, it is possible to evaluate here whether the respective diagnostic function could be carried out at this point in time, if requested. In this regard, it may be advantageous that a virtual request for a diagnostic mode to run is generated and transmitted to the diagnostic coordinator. The operability determined in this way can then be transmitted to the respective diagnostic function for calculation of the ratio, where it can be linked to information about the physical running readiness. In addition to prioritization in the diagnostic coordinator and consideration of the exclusion matrix, the operating coordination may also be taken into account here. This may result in the fact that a diagnostic function in the diagnostic coordinator has the highest priority but could not or should not be set due to the mode currently in effect. In this case, a possible operability is not reported and the numerator is also not incremented accordingly.

According to another aspect of the present invention, a computer program is made available, comprising commands which, in execution of the computer program by a computer, prompt the computer program to carry out the method described above in detail. The computer program according to the invention therefore offers the same advantages as those described in detail with respect to the method according to the present invention. The computer program may be implemented as a computer-readable instruction code in any suitable program language such as JAVA, C++ or C#, for example. The computer program can also be stored via a computer-readable memory medium, such as a data disk, a removable drive, a volatile or nonvolatile memory or an installed memory/processor. The computer program can program a computer or other programmable devices, such as a control unit, in such a way that the desired functions are carried out. Furthermore, the computer program may be made available in a network, such as the Internet, from which it can be downloaded by a user as needed. The computer program may be implemented by means of software and also by means of one or more special electronic circuits and/or in the form of a computer program product, i.e., in hardware or in any hybrid form, i.e., by means of software components and hardware components.

Furthermore, a memory means which may be designed and configured with a computer program stored thereon, which is configured and designed for carrying out a method as described above, is made available. The memory means may be provided in the form of a computer-readable memory medium, such as a data disk, a removable drive, a volatile or nonvolatile memory. Furthermore, a control unit, in particular a vehicle control unit, may be made available with a computer program installed thereon, as described above, said computer program being configured and designed for carrying out a method such as that described above. Therefore, the memory means according to the invention and the control unit according to the invention offer advantages just like the advantages described above.

According to another aspect of the present invention, a vehicle, in particular a vehicle with an internal combustion engine, is made available with a control unit as described above for setting an IUMPR of the vehicle. Thus the vehicle also provides the advantages described above. The vehicle is preferably embodied in the form of a motor vehicle, in particular a passenger vehicle or a utility vehicle or truck. Likewise, the vehicle may also be embodied as a rail vehicle, an aircraft, a water vehicle or a robot.

### BRIEF DESCRIPTION OF THE DRAWINGS

Additional measures that improve the present invention are derived from the following description of various exemplary embodiments of the invention, which are diagramed schematically in the figures. All the features and/or advantages, including structural details and spatial arrangements, derived from the claims, the description or the figures may be essential to the invention either when used alone or in the various combinations.

The drawings show schematically:

FIG. 1 a flow chart to illustrate a method according to one specific embodiment of the present invention, and

FIG. 2 a vehicle having a control unit and a computer program installed thereon for carrying out the method presented in FIG. 1.

### DETAILED DESCRIPTION OF THE INVENTION

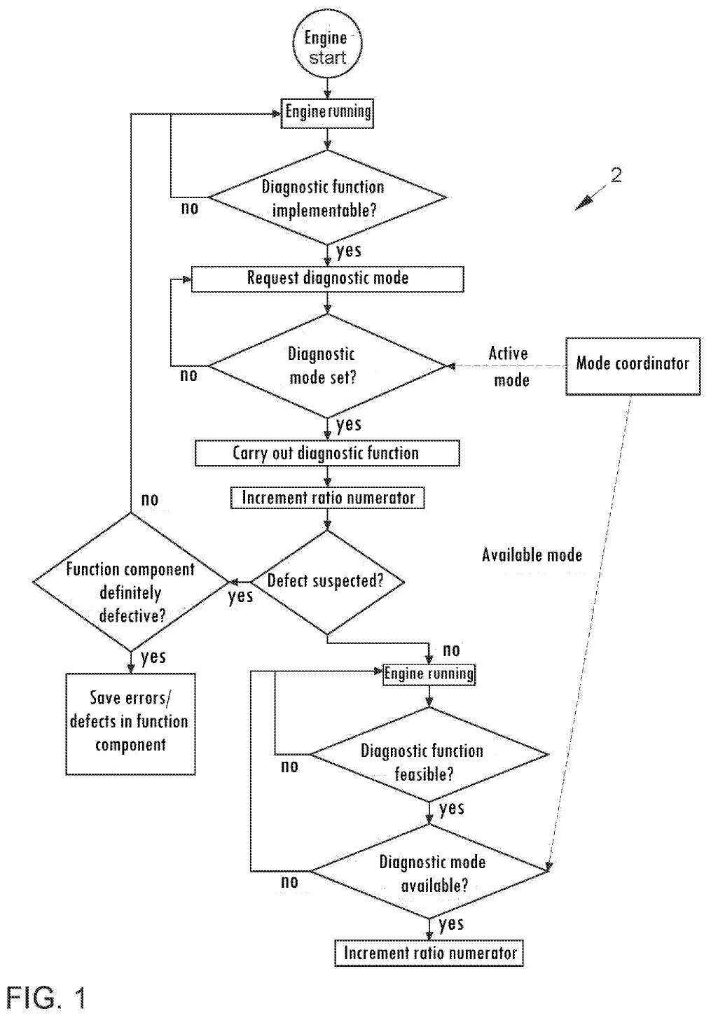

FIG. 1 shows a flow chart to illustrate a method and/or the configuration of a computer program 2 for setting an IUMPR, i.e., ratio of a vehicle 6 according to a preferred specific embodiment. The flow chart is to be considered under the assumption that a diagnostic function requires processing to ascertain whether the function component 1 is in order, and it requires several runs to ascertain that the function component 1 is defective.

As illustrated in FIG. 1, first there is an engine start of an internal combustion engine 4 of vehicle 6. This is detected by the computer program 2 accordingly. Next, on the basis of physical operating parameters of the vehicle 6, such as the rotational speed, the load, the engine temperature and/or the exhaust temperature, it ascertains whether a diagnostic function is capable of being carried out, i.e., running to ascertain the functional capability of a function component 1 of the vehicle 6. In the present example, the function component 1 may be understood to be a catalyst in vehicle 6. If it is ascertained that the diagnostic function cannot be carried out, the method returns to the previous step. If it is ascertained that the diagnostic function can be carried out, then a diagnostic mode, in which the diagnostic function can be carried out is requested. This is carried out until the desired diagnostic mode has been set. By means of a mode coordinator, various active and/or available modes can be thereby coordinated, i.e., set. As soon as the desired diagnostic mode has been set, the respective diagnostic function can be carried out. Next the numerator of the ratio is incremented.

Then there is a test for a possible defect. At the first suspicion of a defect, the method advances to a more detailed error check. If there are not adequate reasons there indicating a defect in the function component 1, the method returns to the beginning and the test procedure begins again from the beginning. If there are sufficient reasons indicating a defect in the function component 1, the defect and/or a corresponding error of the function component 1 is stored. If there is no indication of a defect in the function component 1 from the beginning, then the method begins again with the detection that the engine is running and the verification of whether the diagnostic function is capable of running. If this is the case, with traditional methods it was customary to then increment the numerator of the ratio. However, again in the present case, depending on current operating runs in the vehicle 6 and/or those yet to be performed, it is ascertained whether a diagnostic mode of the function component 1 is in fact available or can be set for carrying out the diagnostic function. Only if this is the case is the numerator of the ratio incremented.

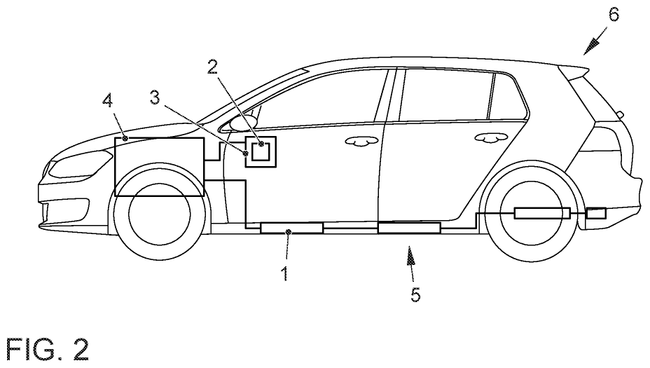

FIG. 2 shows a vehicle 6 having a control unit 3 and a computer program 2 installed therein for setting an IUMPR of the vehicle 6 and/or for carrying out the method described with reference to FIG. 1. The vehicle 6 has an internal combustion engine 4 and an exhaust system 5 connected thereto with the catalyst and/or function component 1 mentioned above as an example.

In addition to the specific embodiments illustrated here, the present invention also allows additional design principles. In other words, the invention should not be considered as limited to the exemplary embodiments explained with reference to the figures.

It is thus possible within the scope of the method for a plurality of diagnostic functions to be prioritized in relation to one another and for it to be ascertained as a function of the prioritized diagnostic functions whether a diagnostic mode of the function component 1 is available or can be set for carrying out a diagnostic function. Furthermore, it is possible that information regarding the possible implementation of the diagnostic function and/or regarding the availability and/or settability of the diagnostic mode can be read out of the control unit 3 of the vehicle 6. It is advantageous if an exclusion matrix is created for predetermining whether or not a plurality of diagnostic functions can take place at least partially at the same time, such that it is ascertained, on the basis of the exclusion matrix, whether a diagnostic mode of the function component 1 is available or can be set for carrying out the diagnostic function. According to a particularly preferred specific embodiment, a test of which diagnostic function with the highest priority diagnostic function can be carried out at least partially simultaneously, and this is tested on the basis of the prioritized diagnostic functions and the exclusion matrix in the order of decreasing priority. In addition, it is also possible for a virtual request for running the diagnostic function to be generated, on the basis of which it is ascertained whether a diagnostic mode of the function component 1 is available or can be set for carrying out the diagnostic function.

According to the method presented here, the possible feasibility of a diagnostic function is calculated with a central evaluation of possible requirements of the diagnostic function. The decision as to which diagnostic function is allowed to run and/or whether a diagnostic function is allowed to run at all is made on the basis of the exclusion matrix and is based on priority in particular. This coordination is additionally linked to the central engine coordination, and it is also possible to evaluate on this basis whether special vehicle and/or engine operating states can be requested, if necessary. It is possible in this way to ensure that, for example, an asymmetric ratio regarding the feasibility of a diagnostic function can be calculated correctly. It should be pointed out here that the present invention relates in particular to the setting of asymmetrical ratios, and the present method is configured preferably accordingly for setting an asymmetrical IUMPR.

The coordination can prioritize the requirements made of it and a potential request for a diagnostic function in relation to one another and decides in this way whether the diagnostic function potentially retains the highest priority at this point in time, i.e., in the case of a request, and could thus be stopped. In this consideration, in addition to the prioritization and the exclusion matrix in the diagnostic coordinator, the prioritization in coordination of operations can also be included in the calculation of a possible feasibility.

### LIST OF REFERENCE NUMERALS

1 function component
2 computer program
3 control unit
4 internal combustion engine
5 exhaust system
6 vehicle

1. A method for setting an IUMPR of a vehicle, wherein the IUMPR comprises a numerator for indicating a number of possible sequences of diagnostic functions and a denominator for indicating a number of predefined operating states that have prevailed in the vehicle, comprising:
ascertaining, on the basis of physical operating parameters of the vehicle, whether at least one diagnostic function can be carried out for ascertaining the functional capability of at least one function component of the vehicle, and
ascertaining, as a function of current operating sequences in the vehicle and/or operating sequences yet to be carried out, whether a diagnostic mode of the at least one function component is available or can be set for carrying out the at least one diagnostic function,
wherein the numerator of the IUMPR is incremented on detecting that the diagnostic mode is available or can be set.

2. The method according to claim 1,
wherein multiple diagnostic functions are prioritized in relation to one another and,
further comprising, depending on the prioritized diagnostic functions, ascertaining whether a diagnostic mode of the at least one function component is available or can be set for carrying out at least one diagnostic function.

3. The method according to claim 1, further comprising reading information about the possible implementation of the at least one diagnostic function and/or about the availability and/or settability of the diagnostic mode out of a control unit of the vehicle.

4. The method according to claim 1, further comprising creating an exclusion matrix for indicating whether or not multiple diagnostic functions can be allowed to take place at least partially at the same time, and ascertaining, on the basis of the exclusion matrix, whether a diagnostic mode of the at least one function component is available or can be set for carrying out the diagnostic function.

5. The method according to claim 4, further comprising performing a test on the basis of the prioritized diagnostic functions as well as the exclusion matrix in order of decreasing priority to ascertain which diagnostic function can be carried out at least partially at the same time with the highest priority diagnostic function.

6. The method according to claim 1, further comprising generating a virtual request for a run of the at least one diagnostic function on the basis of which it is ascertained whether a diagnostic mode of the at least one function component for carrying out the at least one diagnostic function is available or can be set.

7. A computer program comprising commands, which prompt a computer, in execution of the computer program by the computer, to carry out the method according to claim 1.

8. A memory means having a computer program stored therein, configured and embodied for carrying out the method according to claim 1.

9. A control unit having a computer program according to claim 7 installed therein, configured and embodied for carrying out the method according to claim 1.

10. A vehicle having a control unit according to claim 9 for setting an IUMPR of the vehicle.
